(19) United States
(12) Patent Application Publication
(10) Pub. No.: US 2012/0173493 A1
(43) Pub. Date: Jul. 5, 2012

(54) METHOD AND APPARATUS FOR PROVIDING SAFEGUARDING AGAINST MALICIOUS ONTOLOGIES

(75) Inventor: Marwan Sabbouh, Chelmsford, MA (US)

(73) Assignee: Nokia Corporation

(21) Appl. No.: 12/983,701

(22) Filed: Jan. 3, 2011

(51) Int. Cl. G06F 17/30

(52) U.S. Cl. 707/687; 707/E17.005

(57) ABSTRACT

A method for providing a mechanism for safeguarding against malicious ontologies may include causing examination of a received file associated with an ontology to determine a namespace marking for subjects, predicates and objects of each triple of the file that are to be stored in a database, utilizing relationship data corresponding to the namespace marking to identify triples whose subjects or objects do not correspond to the ontology, and determining whether the relationship data enables the triples whose subjects or objects do not correspond to the ontology to be considered as a valid data set for storage in the database. A corresponding apparatus and computer program product are also provided.

### TECHNOLOGICAL FIELD

An embodiment of the present invention relates generally to information management technology and, more particularly, relates to a method and apparatus for providing safeguarding against malicious ontologies.

### BACKGROUND

Communication devices are becoming increasingly ubiquitous in the modern world. In particular, mobile communication devices seem to be popular with people of all ages, socio-economic backgrounds and sophistication levels. Accordingly, users of such devices are becoming increasingly attached to their respective mobile communication devices. Whether such devices are used for calling, emailing, sharing or consuming media content, gaming, navigation or various other activities, people are more connected to their devices and consequently more connected to each other and to the world at large.

Due to advances in processing power, memory management, application development, power management and other areas, communication devices, such as computers, mobile telephones, cameras, multimedia internet devices (MIDs), personal digital assistants (PDAs), media players and many others are becoming more capable. Moreover, the popularity and utility of mobile communication devices has caused many people to rely on their mobile communication devices to connect them to the world for personal and professional reasons. Thus, many people carry their mobile communication devices with them on a nearly continuous basis.

As the usage of communication devices increases, the amount of content that is created and stored is also rapidly increasing. Information systems that support the storage or management of the massive amounts of content that are created often do so with the help of databases. One type of database that is often used to store data is referred to as a triple store. A triple store may be used to store triples or ontologies produced by information systems. Data integration and data sharing may then be accomplished by querying the triple store.

Although the storage of data in a database that is structured as a triple store may enable the storage of triples in a manner that provides for a rich capability for modeling information or creating a knowledge representation, there may be some risks. For example, someone could negatively impact the operation of the database by storing malicious ontologies, triples or data within the database. The malicious ontologies, triples or data may prohibit the database from functioning properly when the malicious items are uploaded.

### BRIEF SUMMARY

A method, apparatus and computer program product are therefore provided to enable the provision of a mechanism for safeguarding against malicious ontologies. In this regard, for example, some embodiments may provide for the use of namespace to mark each file. The namespace may correspond to a particular ontology. Relationships may then be defined for namespaces associated with respective different ontology files to determine which ontology files can be loaded (or maintained) within a data set.

In one example embodiment, a method of providing a mechanism for safeguarding against malicious ontologies is provided. The method may include causing examination of a received file associated with an ontology to determine a namespace marking for subjects, predicates and objects of triples of the file that are to be stored in a database, utilizing relationship data corresponding to the namespace marking to identify triples whose subjects or objects do not correspond to the ontology, and determining whether the relationship data enables the triples whose subjects or objects do not correspond to the ontology to be considered as a valid data set for storage in the database.

In another example embodiment, an apparatus for providing a mechanism for safeguarding against malicious ontologies is provided. The apparatus may include at least one processor and at least one memory including computer program code. The at least one memory and the computer program code may be configured to, with the at least one processor, cause the apparatus to perform at least causing examination of a received file associated with an ontology to determine a namespace marking for subjects, predicates and objects of triples of the file that are to be stored in a database, utilizing relationship data corresponding to the namespace marking to identify triples whose subjects or objects do not correspond to the ontology, and determining whether the relationship data enables the triples whose subjects or objects do not correspond to the ontology to be considered as a valid data set for storage in the database.

In one example embodiment, another apparatus for providing a mechanism for safeguarding against malicious ontologies is provided. The apparatus may include means for causing examination of a received file associated with an ontology to determine a namespace marking for subjects, predicates and objects of triples of the file that are to be stored in a database, means for utilizing relationship data corresponding to the namespace marking to identify triples whose subjects or objects do not correspond to the ontology, and means for determining whether the relationship data enables the triples whose subjects or objects do not correspond to the ontology to be considered as a valid data set for storage in the database.

In one example embodiment, a computer program product for providing a mechanism for safeguarding against malicious ontologies is provided. The computer program product may include at least one computer-readable storage medium having computer-executable program code instructions stored therein. The computer-executable program code instructions may include program code instructions for causing examination of a received file associated with an ontology to determine a namespace marking for subjects, predicates and objects of triples of the file that are to be stored in a database, utilizing relationship data corresponding to the namespace marking to identify triples whose subjects or objects do not correspond to the ontology, and determining whether the relationship data enables the triples whose subjects or objects do not correspond to the ontology to be considered as a valid data set for storage in the database.

An example embodiment of the invention may provide a method, apparatus and computer program product for employment in mobile environments or in fixed environments. As a result, for example, mobile terminal and other computing device users may enjoy an improved ability to store content and access stored content.

### BRIEF DESCRIPTION OF THE DRAWING(S)

Having thus described some embodiments of the invention in general terms, reference will now be made to the accompanying drawings, which are not necessarily drawn to scale, and wherein:

FIG. 1 is a schematic block diagram of a wireless communications system according to an example embodiment of the present invention;

FIG. 2 illustrates a block diagram of an apparatus for providing a mechanism for safeguarding against malicious ontologies according to an example embodiment of the present invention; and

FIG. 3 is a flowchart according to an example method for providing a mechanism for safeguarding against malicious ontologies according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

As indicated above, some embodiments of the present invention may relate to the provision of a mechanism for safeguarding against malicious ontologies. In this regard, for example, some example embodiments may provide for the assignment of a namespace to mark each file. The namespace may correspond to a particular ontology. Relationships may then be defined for namespaces associated with respective different ontology files to determine which ontology files can be loaded (or maintained) within a data set. Thus, for example, when an ontology file is loaded, the file may be scanned to determined of the subjects of the triples in the ontology belong to namespace of the file or to a different namespace. If the subjects belong to the namespace of the file, then the subjects can be loaded or maintained without further interaction. However, if the subjects belong to a different namespace than the namespace of the file, it may be determined as to whether subjects of the different namespace are to be allowed to be asserted in the database or are to be removed based on potentially defined namespace relationships associated with the ontology files. Accordingly, some example embodiments of the present invention may enable ontologies that are allowed to change the definitions of other files to be specified.

In a similar fashion, when an ontology file is loaded, the file may be scanned to determine which of the objects and the predicates of the triples in the ontology belong to the namespace of the file or to a different namespace. If the objects belong to the namespace of the file, then the objects may be loaded or maintained without further interaction. However, if the objects belong to a different namespace than the namespace of the file and the predicate is either owl: equivalentClass, owl: equivalentProperty, or owl: sameAs, it may be determined as to whether objects of the different namespace are to be allowed to be asserted in the database or are to be removed based on potentially defined namespace relationships associated with the ontology files. Accordingly, as indicated above, some example embodiments of the present invention may enable ontologies that are allowed to change the definitions of other files to be specified.

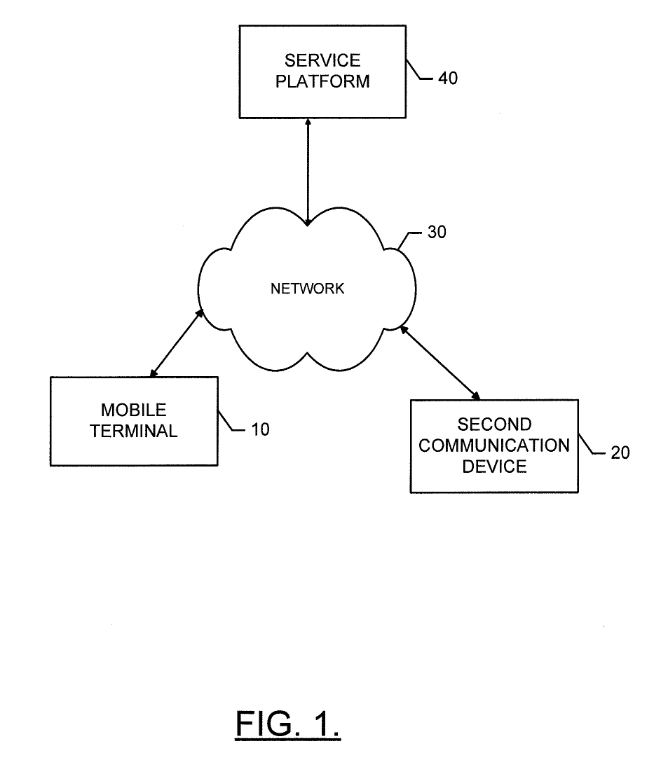

FIG. 1 illustrates a generic system diagram in which a device such as a mobile terminal 10, which may benefit from some embodiments of the present invention, is shown in an example communication environment. As shown in FIG. 1, a system in accordance with an example embodiment of the present invention includes a first communication device (e.g., mobile terminal 10) and a second communication device 20 that may each be capable of communication with a network 30. The second communication device 20 is provided as an example to illustrate potential multiplicity with respect to instances of other devices that may be included in the network 30 and that may practice an example embodiment. The communications devices of the system may be able to communicate with network devices or with each other via the network 30. In some cases, the network devices with which the communication devices of the system communicate may include a service platform 40. In an example embodiment, the mobile terminal 10 (and/or the second communication device 20) is enabled to communicate with the service platform 40 to provide, request and/or receive information.

While an example embodiment of the mobile terminal 10 may be illustrated and hereinafter described for purposes of example, numerous types of mobile terminals, such as portable digital assistants (PDAs), pagers, mobile televisions, mobile telephones, gaming devices, laptop computers, cameras, camera phones, video recorders, audio/video player, radio, electronic books, global positioning system (GPS) devices, navigation devices, or any combination of the aforementioned, and other types of multimedia, voice and text communications systems, may readily employ an example embodiment of the present invention. Furthermore, devices that are not mobile may also readily employ an example embodiment of the present invention in some cases. As such, for example, the second communication device 20 may represent an example of a fixed electronic device that may employ an example embodiment. For example, the second communication device 20 may be a personal computer (PC) or other terminal.

In some embodiments, not all systems that employ embodiments of the present invention may comprise all the devices illustrated and/or described herein. For example, while an example embodiment will be described herein in which either a mobile user device (e.g., mobile terminal 10), a fixed user device (e.g., second communication device 20), or a network device (e.g., the service platform 40) may include an apparatus capable of performing some example embodiments in connection with communication with the network 30, it should be appreciated that some embodiments may exclude one or multiple ones of the devices or the network 30 altogether and simply be practiced on a single device (e.g., the mobile terminal 10 or the second communication device 20) in a stand alone mode.

In an example embodiment, the network 30 includes a collection of various different nodes, devices or functions that are capable of communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like.

One or more communication terminals such as the mobile terminal 10 and the second communication device 20 may be capable of communication with each other via the network 30 and each may include an antenna or antennas for transmitting signals to and for receiving signals from a base site, which could be, for example a base station that is a part of one or more cellular or mobile networks or an access point that may be coupled to a data network, such as a local area network (LAN), a metropolitan area network (MAN), and/or a wide area network (WAN), such as the Internet. In turn, other devices such as processing devices or elements (e.g., personal computers, server computers or the like) may be coupled to the mobile terminal 10 and the second communication device 20 via the network 30. By directly or indirectly connecting the mobile terminal 10, the second communication device 20 and other devices to the network 30, the mobile terminal 10 and the second communication device 20 may be enabled to communicate with the other devices (or each other), for example, according to numerous communication protocols including Hypertext Transfer Protocol (HTTP) and/or the like, to thereby carry out various communication or other functions of the mobile terminal 10 and the second communication device 20, respectively.

Furthermore, although not shown in FIG. 1, the mobile terminal 10 and the second communication device 20 may communicate in accordance with, for example, radio frequency (RF), Bluetooth (BT), Infrared (IR) or any of a number of different wireline or wireless communication techniques, including USB, LAN, wireless LAN (WLAN), Worldwide Interoperability for Microwave Access (WiMAX), WiFi, ultra-wide band (UWB), Wibree techniques and/or the like. As such, the mobile terminal 10 and the second communication device 20 may be enabled to communicate with the network 30 and each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as WLAN, WiMAX, and/or the like and fixed access mechanisms such as digital subscriber line (DSL), cable modems, Ethernet and/or the like.

In an example embodiment, the service platform 40 may be a device or node such as a server or other processing device. The service platform 40 may have any number of functions or associations with various services. As such, for example, the service platform 40 may be a platform such as a dedicated server (or server bank) associated with a particular information source or service (e.g., a data storage and/or management service), or the service platform 40 may be a backend server associated with one or more other functions or services. As such, the service platform 40 represents a potential host for a plurality of different services or information sources. In some embodiments, the functionality of the service platform 40 is provided by hardware and/or software components configured to operate in accordance with known techniques for the provision of information to users of communication devices. However, at least some of the functionality provided by the service platform 40 may be information provided in accordance with an example embodiment of the present invention.

In some embodiments, the mobile terminal 10 (or the second communication device 20) may communicate information (e.g., via the network 30) to be stored at the service platform 40 in a database. As such, the service platform 40 may host a database and perhaps also a database information management entity to manage data being stored at or by the service platform 40. However, in other cases, any or all of the mobile terminal 10, the second communication device 20 and the service platform 40 may include databases and/or database information management entities that may operate in accordance with the description herein of some example embodiments.

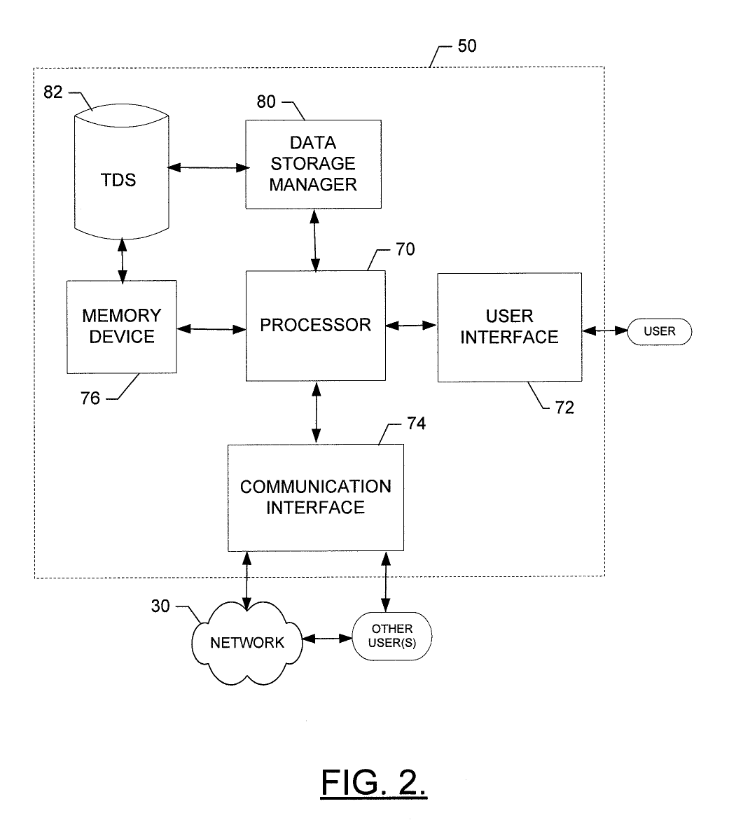

FIG. 2 illustrates a schematic block diagram of an apparatus for providing a mechanism for safeguarding against malicious ontologies according to an example embodiment of the present invention. An example embodiment of the invention will now be described with reference to FIG. 2, in which certain elements of an apparatus 50 for providing a mechanism for safeguarding against malicious ontologies are displayed. The apparatus 50 of FIG. 2 may be employed, for example, on the service platform 40, on the mobile terminal 10 and/or on the second communication device 20. However, the apparatus 50 may alternatively be embodied at a variety of other devices, both mobile and fixed (such as, for example, any of the devices listed above). In some cases, an embodiment may be employed on either one or a combination of devices. Accordingly, some embodiments of the present invention may be embodied wholly at a single device (e.g., the service platform 40, the mobile terminal 10 or the second communication device 20), by a plurality of devices in a distributed fashion or by devices in a client/server relationship (e.g., the mobile terminal 10 and the service platform 40). Furthermore, it should be noted that the devices or elements described below may not be mandatory and thus some may be omitted in certain embodiments.

Referring now to FIG. 2, an apparatus for providing a mechanism for safeguarding against malicious ontologies is provided. The apparatus 50 may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a fixed communication device (e.g., service platform 40) or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied in hardware as one or more of various processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), central processing unit (CPU), a hardware accelerator, a vector processor, a graphics processing unit (GPU), a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, or a combination of hardware and software, that is configured to receive and/or transmit data from/to a network and/or any other device or module in communication with the apparatus. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, soft keys, a microphone, a speaker, or other input/output mechanisms. In an exemplary embodiment in which the apparatus is embodied as a server or some other network devices, the user interface 72 may be limited, or eliminated. However, in an embodiment in which the apparatus is embodied as a communication device (e.g., the mobile terminal 10 or the second communication device 20), the user interface 72 may include, among other devices or elements, any or all of a speaker, a microphone, a display, and a keyboard or the like. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an exemplary embodiment, the processor 70 may be embodied as, include or otherwise control a data storage manager 80, which may form a database information management entity in some embodiments. As such, in some embodiments, the processor 70 may be said to cause, direct or control the execution or occurrence of the various functions attributed to the data storage manager 80 as described herein. The data storage manager 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the data storage manager 80 as described herein. Thus, in examples in which software is employed, a device or circuitry (e.g., the processor 70 in one example) executing the software forms the structure associated with such means.

In an example embodiment, the data storage manager 80 may generally be configured to examine files for namespace markings. In some cases, the data storage manager 80 may also be configured to mark files with namespace information for use as described herein. The data storage manager 80 may also store rules or relationship data defining relationships between various namespaces in terms of establishing which ontologies (e.g., associated with corresponding namespaces) can form valid data sets in connection with other ontologies. Thus, for example, the relationship data may indicate that a particular ontology can be used in connection with another ontology file.

As an example, the data storage manager 80 may examine the namespace (e.g., namespace A) of a particular file having a corresponding ontology (ontology A). The data storage manager 80 may then consult relationship data associated with namespace A to determine whether any other namespaces are allowed to change definitions of files within a file corresponding to ontology A. If, for example, the relationship data associated with namespace A indicates that namespace B is associated with an ontology (ontology B) that can change definitions in a file having ontology A, then any data found within the particular file that has namespace B associated therewith may be permitted to be loaded as a valid data set. Meanwhile, if data found within the particular file has namespace C (which may be associated with ontology C) associated therewith, and there is no relationship data for namespace C (or negative relationship data indicating that namespace C is not valid for namespace C files), then the data that has namespace C may not be loaded, be prevented from being loaded, or may be removed from the file since such data does not represent a valid data set according to the relationship data accessed by the data storage manager 80. Thus, since the relationship data can specify the ontology files that can change the definitions of other ontology files, any data associated with an ontology that is not specified (e.g., as having file definition changing authority) in the relationship data of a particular ontology may be considered to be invalid and may be blocked or removed.

Thus, for example, the relationship data may be considered to be positive relationship data (e.g., indicating that a certain ontology can change the definitions of another file) or negative relationship data (e.g., indicating that a certain ontology cannot change the definitions of another file). However, in some embodiments, the absence of relationship data may be considered to be negative relationship data and thus, all relationship data may be considered to be positive relationship data. As yet another alternative, some embodiments may define that the absence of relationship data is considered to be positive relationship data and thus, all relationship data may be considered to be negative relationship data.

Example embodiments may be used in connection with any of a plurality of memory management systems. However, an example embodiment will be described in the context of a triple data store (TDS) 82. The TDS 82 may store information in the form of triples based on the control provided by the data storage manager 80 (and ultimately processor 70). The TDS 82 may be a long-term, persistent triple data store that may be available for sending data to other applications as strongly-typed items. Alternatively or additionally, the data stored in the TDS 82 may be available for querying or searching and reporting or driving applications. Once posted to the TDS, data can trigger or otherwise be used in connection with rule processing, including potentially complex rule processing, based on trigger mappings within a particular knowledge model. As such, for example, a particular condition may be monitored by setting up rules that extract specific data from the TDS 82 for use in one or more analytic programs or other applications. Resource description framework (RDF) is an example of one framework for storing information in the TDS 82.

According to some example embodiments, an ontology file (marked with a namespace) may be received for loading into the TDS 82. The data storage manager 80 may then examine the file and determine (e.g., based on relationship data for the corresponding namespace and its associated ontology) whether subjects of the data to be loaded into the TDS 82 belong to a different namespace and, if so, determine whether that different namespace is associated with an ontology that is allowed to change definitions in another ontology file (namely the ontology associated with the namespace of the received file). The data may then either be permitted to be loaded or be prevented from loading based on the relationship data.

RDF is a triple based format that is based on subject, object and predicate information. The subject and object are linked through the predicate. Using such triples, it may be possible to formulate or describe any data down to a lower form. In an exemplary embodiment, an RDF based representation may be used to describe resources along with additional metadata and descriptions. In an example embodiment RDF terms may be defined such that, for example, I is a set of all international resource identifiers (IRIs), RDF-L is a set of all RDF Literals, RDF-B is a set of all blank nodes in RDF graphs, and the set of RDF Terms, RDF-T, is I union RDF-L union RDF-B. A triple may then, for example, be defined as a member of the set RDF-T×I×RDF-T. An RDF dataset may be a set: {(<u2>, G2), . . . (<un>, Gn)}, where: Gi are graphs, each <ui> is an IRI, each <ui> is distinct, and (<ui>, Gi) is called named graph. In an example embodiment, a graph (<u1>,G1) entails a triple t, if and only if t is a member of the closure of (<u1>,G1) or C (G1).

Disjoint is a relation between two IRIs <u1>, <u2> with each IRI corresponding to named graphs (<u1>,G1), (<u2>,G2) . Hence, (<u1>, Disjoint, <u2>) is equivalent to: for all RDF-T terms t in G2→(t, IRI, IRI) is not a member of G1 union C (G1) and (IRI, property, t) is not a member of G1 union C (G1), where property is either web ontology language (owl): equivalentClass, owl: equivalentProperty, or owl: sameAs. In some cases, the relation Disjoint is not symmetric.

An RDF dataset V: {(<u1>,G1), (<u2>,G2)} comprised of two named graphs (<u1>,G1), (<u2>,G2) may be valid if: (<u1>, Disjoint, <u2>). A named graph (<u1>,G1), can be added to a valid RDF dataset V:{(<u1>, G1), (<u2>, G2), . . . (<un>, Gn)}, if: for all named graph (<ui>,Gi) in V, the RDF dataset {(<u1>,G1), (<ui>,Gi)} is valid. An RDF dataset V: {(<u1>,G1), (<u2>,G2)} comprised of two named graphs (<u1>,G1), (<u2>,G2) is non-valid RDF dataset if: there exists RDF-T t in G2 such that (t, IRI, IRI) is a member of G1 union C (G1) or (IRI, property, t) is a member of G1 union C (G1), where the property is either owl: equivalentClass, owl: equivalentProperty, or owl: sameAs.

In some embodiments, the terms defined in the set of the semantic web specifications have a special significance as they constitute the core semantic web vocabulary. Therefore, in some cases it may be considered to be important that no ontology changes the meaning or definitions of the RDF terms that are part of the semantic web specifications. This may be referred to as ontology hijacking. As an example, a named graph (<u1>,G1), can be added to the valid RDF dataset W:{(<u1>,G1), (<RDF>, RDF), (<RDFS>, RDFS), (<OWL>, OWL)} if: (<u1>, Disjoint, <RDF>) and (<u1>, Disjoint, <RDFS>) and (<u1>, Disjoint, <OWL>), where: <RDFS> refers to http://www.w3.org/2000/01/rdf-schema#, <OWL> refers to http://www.w3.org/2002/07/owl#, and <RDF> refers to http://www.w3.org/1999/02/22-rdf-syntax-ns#. This may imply that for all RDF-T t in RDF union RDFS union OWL (t, IRI, IRI) is not a member of G1 union C (G1) and (IRI, property, t) is not a member of G1 union C (G1), where property is either owl: equivalentClass, owl: equivalentProperty, or owl: sameAs. Any triple not meeting the above condition may result in a non-valid RDF dataset W (and therefore appear to be an example of ontology hijacking).

As an example, foaf (friend of a friend) is a machine-readable ontology that is a descriptive vocabulary that is expressed using RDF and OWL. To illustrate the definitions provided above, Table 1 includes some examples of bad or malicious foaf triples.

```
TABLE 1
<rdf:Description rdf:about=“http://xmlns.com/foaf/0.1/tipjar”>
    <owl:equivalentProperty
rdf:resource=“http://www.w3.org/2000/01/rdf-schema#domain” />
</rdf:Description>
<rdf:Description
rdf:about=“http://www.w3.org/2000/01/rdf-schema#Class”>
  <rdf:type rdf:resource=“http://www.w3.org/2002/07/owl#Class” />
  </rdf:Description>
<rdf:Description
rdf:about=“http://www.w3.org/2000/01/rdf-schema#seeAlso”>
  <rdf:type rdf:resource=“http://www.w3.org/2002/07/owl#Class” />
  </rdf:Description>
  <rdf:Description
  rdf:about=“http://www.w3.org/1999/02/22-rdf-syntax-ns#Property”>
  <rdf:type rdf:resource=“http://www.w3.org/2002/07/owl#Class” />
  </rdf:Description>
  <rdf:Description
  rdf:about=“http://xmlns.com/foaf/0.1/OnlineChatAccount”>
  <owl:equivalentClass
  rdf:resource=“http://www.w3.org/2002/07/owl#Class” />
  </rdf:Description
```

Using the TopBraid composer, again as an example, foaf may be loaded and the entailed triples may be calculated and explicitly asserted into the graph (<foaf>, foaf). Finally, using SPARQL (SPARQL Protocol and RDF Query Language), it can be tested as to whether (<foaf>, foaf) can be added to the valid RDF dataset W: {(<foaf>, foaf), (<RDF>, RDF), (<RDFS>, RDFS), (<OWL>, OWL)}. Table 2 below provides an example.

```
TABLE 2
PREFIX rdfs: <http://www.w3.org/2000/01/rdf-schema#>
PREFIX owl: <http://www.w3.org/2002/07/owl#>
SELECT DISTINCT ?z ?y ?c4
FROM NAMED <http://www.w3.org/2000/01/rdf-schema>
FROM NAMED <http://www.w3.org/2002/07/owl>
FROM NAMED <file:/C:/Users/SABBOUH/Documents/afy10/
Musicontology/nmo-software/software/trunk/nmo/nmo-ontology/
TopBraid/TBC/22-rdf-syntax-ns.rdf>
WHERE {
{
GRAPH <http://www.w3.org/2000/01/rdf-schema> {
    ?z ?w ?u .
    } .
}
UNION {
GRAPH <file:/C:/Users/SABBOUH/Documents/afy10/Musicontology/
nmo-software/software/trunk/nmo/nmo-ontology/TopBraid/
TBC/22-rdf-syntax-ns.rdf> {
          ?z ?b ?c .
          } .
}
UNION {
GRAPH <http://www.w3.org/2002/07/owl> {
          ?z ?b1 ?c1 .
          } .
}
UNION {
          ?z ?c7 ?c4.
  FILTER ((?c7 = owl:equivalentProperty || ?c7 = owl:sameAs || ?c7 =
owl:equivalentClass) )
  FILTER ( regex (str(?c4),“\hat{ }HTTP://www.w3.org”,“i”))
          }
?z ?y ?c4 .
}
```

Running the SPARQL query in Table 2 may return the triples of Table 3 below.

TABLE 3

| [z] | y | c4 |
|---|---|---|
| foaf:OnlineChatAccount | rdfs:subClassOf | owl:Class |
| foaf:OnlineChatAccount | owl:equivalentClass | owl:Class |
| foaf:OnlineChatAccount | rdf:type | owl:Class |
| foaf:tipjar | owl:equivalentProperty | rdfs:domain |
| foaf:tipjar | rdfs:subPropertyOf | rdfs:domain |
| owl:Class | rdf:type | owl:Class |
| owl:Thing | rdfs:label | A thing |
| rdf:Property | rdf:type | owl:Class |
| rdfs:Class | rdf:type | owl:Class |
| rdfs:seeAlso | rdf:type | owl:Class |

When the bad triples of Table 1 are fed into the example code of Table 2, the results of Table 3 may be received indicating non-valid RDF datasets. As shown in Table 3, the triples originated from Table 1 are included except for the triple (owl:Thing, rdfs:label, A thing) which originated from foaf.

To facilitate further discussion, assume that the condition for a valid RDF dataset is restated such that, Disjoint is a relation between two IRIs <u1>, <u2> with each IRI corresponding to named graphs (<u1>,G1), (<u2>,G2); and (<u1>, Disjoint, <u2>) is equivalent to: for all RDF-T terms t in G2→(t, IRI, IRI) is not a member of G1 union C (G1) and (IRI, property, t) is not a member of G1 union C (G1), where property is either owl: equivalentClass, owl: equivalentProperty, or owl: sameAs. The above condition has two parts to it. For the example above, the first part states that no RDF-T term that is defined in the RDF, RDFS, and Owl specifications can be the subject of a triple in foaf. This is fairly intuitive to understand and may act as negative relationship data. However the second part of the condition states that no RDF-T term that is defined in the RDF, RDFS, and Owl specifications can be the object of a triple, if the property is either owl: equivalentClass, owl: equivalentProperty, or owl: sameAs. At first, this part may seem to be superfluous and unnecessary due to the following inference rules:
1. (IRI1, equivalentClass, IRI2) is equivalent to (IRI1, subClassOf, IRI2) and (IRI2, subClassOf, IRI1);
2. (IRI1, equivalentProperty, IRI2) is equivalent to (IRI1, subPropertyOf, IRI2) and (IRI2, subPropertyOf, IRI1); and
3. (IRI1, sameAs, IRI2) is equivalent to (IRI2, sameAs, IRI1),
   where IRI2 is a term in either RDF, RDFS, or OWL.

When the inference rule number 1 is applied on the bad triples of Table 1, the entailed graph for foaf may have the following triples:

| | | |
|---|---|---|
| rdfs:domain | rdfs:subPropertyOf | foaf:tipjar |

However, in some cases, an inference engine may have difficulty generating the above inferences without the second part of the condition.

A typical solution to dealing with the potential for encountering bad or invalid triples within a particular ontology would likely be based on inferencing. However, inferencing is not guaranteed to function in the presence of bad triples. Example embodiments may therefore be implemented within the network structure or class structure for its basic operation. Thus, example embodiments may be relatively easy to implement as part of a process.

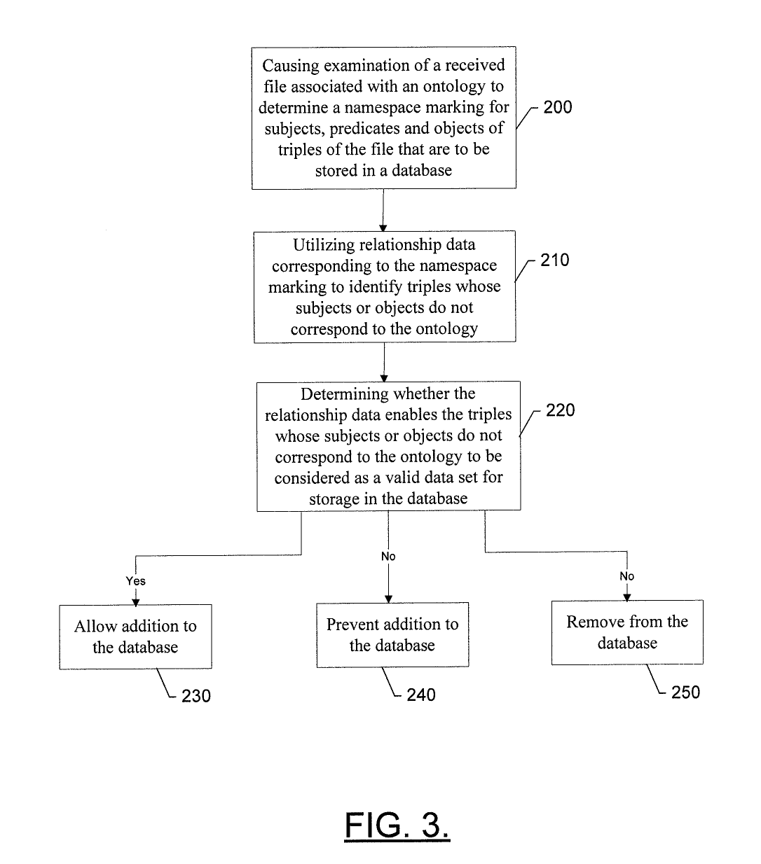

FIG. 3 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or network device and executed by a processor in the user terminal or network device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 3, may include causing examination of a received file associated with an ontology to determine a namespace marking for subjects, predicates and objects of triples of the file that are to be stored in a database at operation 200, utilizing relationship data corresponding to the namespace marking to identify triples whose subjects or objects do not correspond to the ontology at operation 210, and determining whether the relationship data enables the triples whose subjects or objects do not correspond to the ontology to be considered as a valid data set for storage in the database at operation 220.

In some embodiments, certain ones of the operations above may be modified or further amplified as described below. Moreover, in some embodiments additional optional operations may also be included (some examples of which are shown in dashed lines in FIG. 3). It should be appreciated that each of the modifications, optional additions or amplifications below may be included with the operations above either alone or in combination with any others among the features described herein. In some embodiments, the method may further include allowing the triples that do not correspond to the ontology to be added to the database in response determining that the relationship data enables the triples that do not correspond to the ontology to be considered as a valid data set for storage in the database at operation 230, preventing the triples that do not correspond to the ontology from being added to the database in response determining that the relationship data does not enable the triples that do not correspond to the ontology to be considered as a valid data set for storage in the database at operation 240, or removing the triples that do not correspond to the ontology from the database in response determining that the relationship data does not enable the triples that do not correspond to the ontology to be considered as a valid data set for storage in the database at operation 250. In an example embodiment, causing examination of the received file may include determining the namespace marking for subjects, predicates and objects of a triple to be stored in a triple data store database. In some cases, utilizing the relationship data may include determining a presence of positive relationship data indicating that ontology files associated with a different namespace are allowed to change definitions of the received ontology file. In an example embodiment, utilizing the relationship data may include determining a presence of negative relationship data indicating that ontology files associated with a different namespace are not allowed to change definitions of the received ontology file.

In an example embodiment, an apparatus for performing the method of FIG. 3 above may comprise a processor (e.g., the processor 70) configured to perform some or each of the operations (200-250) described above. The processor may, for example, be configured to perform the operations (200-250) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-250 may comprise, for example, the data storage manager 80. Additionally or alternatively, at least by virtue of the fact that the processor 70 may be configured to control or even be embodied as the data storage manager 80, the processor 70 and/or a device or circuitry for executing instructions or executing an algorithm for processing information as described above may also form example means for performing operations 200-250.

In some cases, the operations (200-250) described above, along with any of the modifications may be implemented in a method that involves facilitating access to at least one interface to allow access to at least one service via at least one network. In such cases, the at least one service may be said to perform at least operations 200 to 250.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
causing examination of a received file associated with an ontology to determine a namespace marking for subjects, predicates and objects of triples of the file that are to be stored in a database;
utilizing relationship data corresponding to the namespace marking to identify triples whose subjects or objects do not correspond to the ontology; and
determining whether the relationship data enables the triples whose subjects or objects do not correspond to the ontology to be considered as a valid data set for storage in the database.

2. The method of claim 1, wherein causing examination of the received file comprises determining the namespace marking for subjects, predicates and objects of triples to be stored in a triple data store database.

3. The method of claim 1, wherein utilizing the relationship data comprises determining a presence of positive relationship data indicating that ontology files associated with a different namespace determined for a subject or object of a triple are allowed to change definitions of the received ontology file.

4. The method of claim 1, wherein utilizing the relationship data comprises determining a presence of negative relationship data indicating that ontology files associated with a different namespace determined for a subject or object of a triple are not allowed to change definitions of the received ontology file.

5. The method of claim 1, further comprising allowing the triples that do not correspond to the ontology to be added to the database in response determining that the relationship data enables the subjects, predicates and objects that do not correspond to the ontology to be considered as a valid data set for storage in the database.

6. The method of claim 1, further comprising preventing the triples that do not correspond to the ontology from being added to the database in response determining that the relationship data does not enable the triples that do not correspond to the ontology to be considered as a valid data set for storage in the database.

7. The method of claim 1, further comprising removing the triples that do not correspond to the ontology from the database in response determining that the relationship data does not enable the triples that do not correspond to the ontology to be considered as a valid data set for storage in the database.

8. An apparatus comprising at least one processor and at least one memory including computer program code, the at least one memory and the computer program code configured to, with the at least one processor, cause the apparatus at least to:
cause examination of a received file associated with an ontology to determine a namespace marking for subjects, predicates and objects of triples of the file that are to be stored in a database;
utilize relationship data corresponding to the namespace marking to identify triples whose subjects or objects that do not correspond to the ontology; and
determine whether the relationship data enables the triples whose subjects or objects do not correspond to the ontology to be considered as a valid data set for storage in the database.

9. The apparatus of claim 8 wherein the at least one memory and computer program code are configured to, with the at least one processor, cause the apparatus to cause examination of the received file by determining the namespace marking for subjects, predicates and objects of triples to be stored in a triple data store database.

10. The apparatus of claim 8 wherein the at least one memory and computer program code are configured to, with the at least one processor, cause the apparatus to utilize the relationship data by determining a presence of positive relationship data indicating that ontology files associated with a different namespace are allowed to change definitions of the received ontology file.

11. The apparatus of claim 8 wherein the at least one memory and computer program code are configured to, with the at least one processor, cause the apparatus to utilize the relationship data by determining a presence of negative relationship data indicating that ontology files associated with a different namespace are not allowed to change definitions of the received ontology file.

12. The apparatus of claim 8 wherein the at least one memory and computer program code are further configured to, with the at least one processor, cause the apparatus to allow the triples that do not correspond to the ontology to be added to the database in response determining that the relationship data enables the triples that do not correspond to the ontology to be considered as a valid data set for storage in the database.

13. The apparatus of claim 8 wherein the at least one memory and computer program code are further configured to, with the at least one processor, cause the apparatus to prevent the triples that do not correspond to the ontology from being added to the database in response determining that the relationship data does not enable the triples that do not correspond to the ontology to be considered as a valid data set for storage in the database.

14. The apparatus of claim 8 wherein the at least one memory and computer program code are configured to, with the at least one processor, cause the apparatus to remove the triples that do not correspond to the ontology from the database in response determining that the relationship data does not enable the subjects, predicates and objects that do not correspond to the ontology to be considered as a valid data set for storage in the database.

15. The apparatus of claim 8, wherein the apparatus is a mobile terminal and further comprises user interface circuitry configured to facilitate user control of at least some functions of the mobile terminal.

16. A computer program product comprising at least one computer-readable storage medium having computer-executable program code instructions stored therein, the computer-executable program code instructions including program code instructions that when executed at least cause an apparatus to:
cause examination of a received file associated with an ontology to determine a namespace marking for subjects, predicates and objects of triples of the file that are to be stored in a database;
utilize relationship data corresponding to the namespace marking to identify triples whose subjects or objects do not correspond to the ontology; and
determine whether the relationship data enables the triples whose subjects or objects do not correspond to the ontology to be considered as a valid data set for storage in the database.

17. The computer program product of claim 16, wherein program code instructions for causing examination of the received file include instructions for determining the namespace marking for subjects, predicates and objects of triples to be stored in a triple data store database.

18. The computer program product of claim 16, wherein program code instructions for utilizing the relationship data include instructions for determining a presence of positive relationship data indicating that ontology files associated with a different namespace are allowed to change definitions of the received ontology file.

19. The computer program product of claim 16, wherein program code instructions for utilizing the relationship data include instructions for determining a presence of negative relationship data indicating that ontology files associated with a different namespace are not allowed to change definitions of the received ontology file.

20. The computer program product of claim 16, further comprising program code instructions for allowing the triples that do not correspond to the ontology to be added to the database in response determining that the relationship data enables the triples that do not correspond to the ontology to be considered as a valid data set for storage in the database, preventing the triples that do not correspond to the ontology from being added to the database in response determining that the relationship data does not enable the triples that do not correspond to the ontology to be considered as a valid data set for storage in the database, or removing the triples that do not correspond to the ontology from the database in response determining that the relationship data does not enable the triples that do not correspond to the ontology to be considered as a valid data set for storage in the database.
